(19) United States
(12) Patent Application Publication
(10) Pub. No.: US 2013/0029861 A1
(43) Pub. Date: Jan. 31, 2013

(54) Method for Detecting a Plurality of Nucleotide Polymorphisms at a Single Wavelength Using a Plurality of Oligonucleotides Modified With Fluorescent Dye Having the Same or Close Detection Wavelength

(71) Applicant: Aki Iguchi, Kyoto-shi (JP)

(72) Inventor: Aki Iguchi, Kyoto-shi (JP)

(73) Assignee: ARKRAY, Inc., Kyoto (JP)

(21) Appl. No.: 13/484,371

(22) Filed: May 31, 2012

(30) Foreign Application Priority Data
May 31, 2011 (JP) 2011-122900

(51) Int. Cl. C40B 30/04; C40B 40/06

(52) U.S. Cl. 506/9; 506/16

(57) ABSTRACT

The present disclosure includes a method for simultaneously detecting a plurality of nucleotide polymorphisms, comprising detecting a plurality of nucleotide polymorphisms at a single wavelength by using a plurality of oligonucleotides labeled with a dye, each of which hybridizes to a region containing each of the plurality of nucleotide polymorphisms.

### CROSS-REFERENCE TO RELATED APPLICATION

This application claims priority from Japanese Patent Application No. 2011-122900 filed on May 31, 2011, the subject matter of which is incorporated herein by reference in its entirety.

### SEQUENCE LISTING SUBMISSION VIA EFS-WEB

A computer readable text file, entitled “SequenceListing.txt,” created on or about May 31, 2012 with a file size of about 2 kb contains the sequence listing for this application and is hereby incorporated by reference in its entirety.

### TECHNICAL FIELD

The present disclosure relates to a method for detecting a plurality of nucleotide polymorphisms at a single wavelength using a plurality of oligonucleotides modified with a dye that is the same or close to each other in detection wavelength.

### BACKGROUND ART

There are many methods for analyzing mutation of a target nucleic acid using a dye-labeled probe.

JP2002-355084A describes a mutation analysis method based on the results of a melting curve analysis performed using a fluorescent dye-labeled nucleic acid probe after amplification of a region containing a mutation by PCR. In JP2002-355084A, claim 13 states that “detection is performed at at least the same number of wavelengths as the number of kinds of novel nucleic acid probes for detection of nucleic acids.” Thus, when a plurality of probes are used as described in JP2002-355084A, each of the probes used is labeled with a fluorescent dye having a different wavelength.

JP2006-166808A also describes a method for detecting a genetic mutation using a solid-phased probe. As claim 8 of JP2006-166808A states that “a plurality of kinds of fluorescent substances emitting fluorescent light with different wavelengths are bonded”, when a plurality of probes is used as described in JP2006-166808A, each of the probes used is labeled with a fluorescent dye having a different wavelength.

As mentioned above, in JP2002-355084A and JP2006-166808A, when using a plurality of probes, each of the probes is labeled with a fluorescent dye having a different wavelength.

In JP2002-355084A and JP2006-166808A, detection requires different fluorescent wavelengths in numbers equal to or more than the number of the probes (namely, the number of mutations desired to be detected). However, when there is a limit to the kinds of fluorescent wavelengths that may be detected by a detection apparatus or when there is a limit to the kinds of fluorescent molecules that may be modified on a probe, the number of detectable mutations is also limited. Additionally, in such a case, it is necessary to detect different genetic mutations several times using different reagents, which requires time and cost.

### SUMMARY OF SOME EMBODIMENTS OF THE PRESENT DISCLOSURE

One object of the present invention according to some embodiments is to provide a method for detecting many different nucleotide polymorphisms at one time, even when there is a limit to the kinds of fluorescent wavelengths detectable by a detection apparatus or even when there is a limit to the kinds of fluorescent molecules that may be modified on a probe.

The present disclosure describes that a plurality of nucleotide polymorphisms may be simultaneously detected at a single wavelength by adding, to a single reaction system, a plurality of probes labeled with a fluorescent dye that are the same or close to each other in detection wavelength and designed such that Tm values are close to each other.

Specifically, the present disclosure includes:
(1) A method for simultaneously detecting a plurality of nucleotide polymorphisms, comprising detecting a plurality of nucleotide polymorphisms at a single wavelength by using a plurality of oligonucleotides labeled with a fluorescent dye, each of which hybridizes to a region containing each of the plurality of nucleotide polymorphisms, wherein

the fluorescent dyes labeling the plurality of oligonucleotides are the same or close to each other in detection wavelength;

the plurality of oligonucleotides are designed such that Tm values of the plurality of oligonucleotides for each of the sequences of said regions to be hybridized containing a first genotype of the nucleotide polymorphisms are close to each other; and

each of the plurality of oligonucleotides is designed such that Tm value for the sequence of the region to be hybridized containing the first genotype is distant from Tm value for the sequence of said region to be hybridized containing a second genotype by 3° C. or more.
(2) The method according to (1), wherein a difference between the Tm values of the plurality of oligonucleotides for each of the sequences of said regions to be hybridized containing the first genotype is 0 to 4° C.
(3) The method according to (1), wherein a difference between the Tm values of the plurality of oligonucleotides for each of the sequences of said regions to be hybridized containing the first genotype is 0 to 2° C.
(4) The method according to (1), wherein a difference between the Tm values of the plurality of oligonucleotides for each of the sequences of said regions to be hybridized containing the first genotype is 0 to 1° C.
(5) A method of detecting nucleotide polymorphisms, comprising, simultaneously or sequentially, performing the nucleotide polymorphism detection method according to (1) and a nucleotide polymorphism detection method using one or more fluorescent dye detection wavelengths other than and not close to the wavelength to be used in the nucleotide polymorphism detection method according to (1).
(6) A method of detecting nucleotide polymorphisms, comprising, simultaneously or sequentially, performing the nucleotide polymorphism detection method according to (1) and a nucleotide polymorphism detection method using two or more fluorescent dye detection wavelengths other than and not close to the wavelength to be used in the nucleotide polymorphism detection method according to (1).
(7) The method according to (1), wherein the first genotype-containing sequence is a wild type sequence and the second genotype-containing sequence is a sequence having a substitution mutation, an insertion mutation, and/or a deletion mutation of one or more nucleotides in the wild type sequence.
(8) The method according to (1), wherein the oligonucleotides are nucleotide polymorphism detection probes in which the oligonucleotides emit fluorescence when not hybridized to a target sequence, and fluorescence intensity decreases or increases when the oligonucleotides are hybridized to the target sequence.
(9) The method according to (8), wherein the oligonucleotides are nucleotide polymorphism detection probes in which the fluorescence intensity decreases when the oligonucleotides are hybridized to the target sequence.
(10) A kit for simultaneously detecting a plurality of nucleotide polymorphisms at a single wavelength, the kit comprising nucleotide polymorphism detection probes comprising a plurality of oligonucleotides labeled with a fluorescent dye, each of which hybridizes to a region containing each of the plurality of nucleotide polymorphisms, wherein

the fluorescent dyes labeling the plurality of oligonucleotides are the same or close to each other in detection wavelength,

the plurality of oligonucleotides are designed such that Tm values of the plurality of oligonucleotides for each of the sequences of said regions to be hybridized containing a first genotype of the nucleotide polymorphisms are close to each other; and

each of the plurality of oligonucleotides is designed such that Tm value for the sequence of the region to be hybridized containing the first genotype is distant from Tm value for the sequence of said region to be hybridized containing a second genotype by 3° C. or more.
(11) A method for predicting a medicinal efficacy and/or a physical predisposition in an individual, comprising measuring the presence or absence of a nucleotide polymorphism(s) associated with the medicinal efficacy and/or the physical predisposition, by detecting the plurality of nucleotide polymorphisms by the method according to (1).
(12) A nucleotide polymorphism detection apparatus comprising:

a reaction section containing a plurality of oligonucleotides labeled with a fluorescent dye, each of which hybridizes to a region containing each of the plurality of nucleotide polymorphisms;

a liquid sending section feeding a sample and/or a reaction solution to the reaction section;

a light source section emitting light for exciting fluorescence in the reaction section;

a control section controlling temperature of the reaction section; and

a detection section detecting the fluorescence, wherein

the fluorescent dyes labeling the plurality of oligonucleotides are the same or close to each other in detection wavelength,

the plurality of oligonucleotides are designed such that Tm values of the plurality of oligonucleotides for each of the sequences of said regions to be hybridized containing a first genotype of the nucleotide polymorphisms are close to each other; and

each of the plurality of oligonucleotides is designed such that Tm value for the sequence of the region to be hybridized containing the first genotype is distant from Tm value for the sequence of said region to be hybridized containing a second genotype by 3° C. or more.
(13) A nucleotide polymorphism determination system comprising:

a reaction system containing a plurality of oligonucleotides labeled with a fluorescent dye, each of which hybridizes to a region containing each of the plurality of nucleotide polymorphisms;

a liquid sending system feeding a sample and/or a reaction solution to the reaction system;

a light source system emitting light for exciting fluorescence in the reaction system;

a control section controlling temperature of the reaction system;

a detection system detecting the fluorescence; and

a determination system determining the nucleotide polymorphism based on a detection result, wherein

the fluorescent dyes labeling the plurality of oligonucleotides are the same or close to each other in detection wavelength,

the plurality of oligonucleotides are designed such that Tm values of the plurality of oligonucleotides for each of the sequences of said regions to be hybridized containing a first genotype of the nucleotide polymorphisms are close to each other; and

each of the plurality of oligonucleotides is designed such that Tm value for the sequence of the region to be hybridized containing the first genotype is distant from Tm value for the sequence of said region to be hybridized containing a second genotype by 3° C. or more.

The method described herein may detect many nucleotide polymorphisms at one time even when using an apparatus that may detect a limited number of wavelengths and even when there are few kinds of fluorescent molecules that may modify probes.

### BRIEF DESCRIPTION OF THE DRAWINGS

FIG. 1A show relationships between variations in the fluorescence intensities of Pacific Blue and BODIPY FL per unit time (d fluorescence intensity increase/t) and temperatures in a Tm analysis of a case of Example 1 using probes: 3PB-EGFR-insWT-R5 (SEQ ID NO: 9), 3PB-EGFR-insWT-F4 (SEQ ID NO: 10), and 3PB-EGFR-ins7-F1 (SEQ ID NO: 11), a template: EGFR-e20-ins-WT-F (SEQ ID NO: 1), and fluorescent dyes: Pacific Blue and BODIPY FL. The left chart shows variations in Pacific Blue and the right chart shows variations in BODIPY FL. The vertical axes represent the variations in the fluorescence intensities per unit time (d fluorescence intensity increase/t) and the horizontal axes represent temperatures (° C.). The drawings below show the results of the same experimentations as above performed by combining with different templates.

FIGS. 1B show the results of Example 1 using a template: EGFR-e20-ins9-F (SEQ ID NO: 2).

FIGS. 1C show the results of Example 1 using a template: EGFR-e20-insCAC-R3 (SEQ ID NO: 14).

FIGS. 1D show the results of Example 1 using a template: EGFR-e20-insTGCGTG-F (SEQ ID NO: 4).

FIG. 1E show the results of Example 1 using a template: EGFR-e20-insAACCCC-R6 (SEQ ID NO: 16).

FIGS. 1F show the results of Example 1 using a template: EGFR-e20-insCCCCAC-R7 (SEQ ID NO: 17).

FIGS. 1G show the results of Example 1 using a template: EGFR-e20-insAACCCCCAC-R8 (SEQ ID NO: 18).

FIGS. 1H show the results of Example 1 using a template: EGFR-e20-insCACGTG-R9 (SEQ ID NO: 19).

FIG. 2A shows a relationship between variation in the fluorescence intensity of Pacific Blue per unit time (d fluorescence intensity increase/t) and temperature in a Tm analysis of a case of Example 2 using probes: 3PB-858-G-PM (SEQ ID NO: 20) and 3PB-3A4-G-PM (SEQ ID NO: 21), a template: 858-mm (SEQ ID NO: 22) 100% and 3A4-mm (SEQ ID NO: 24) 100%, and a fluorescent dye: Pacific Blue. The vertical axis represents the variation in the fluorescence intensity per unit time (d fluorescence intensity increase/t) and the horizontal axis represents temperature (° C.). The drawings below show the results of the same experimentations as above performed by combining with different templates.

FIG. 2B shows the result of Example 2 using templates: 858-mm (SEQ ID NO: 22) 50%, 858-PM (SEQ ID NO: 23) 50%, and 3A4-mm (SEQ ID NO: 24) 100%.

FIG. 2C shows the result of Example 2 using templates: 858-mm (SEQ ID NO: 22) 90%, 858-PM (SEQ ID NO: 23) 10%, and 3A4-mm (SEQ ID NO: 24) 100%.

FIG. 2D shows the result of Example 2 using templates: 858-mm (SEQ ID NO: 22) 100%, 3A4-mm (SEQ ID NO: 24) 50%, and 3A4-PM (SEQ ID NO: 25) 50%.

FIG. 2E shows the result of Example 2 using templates: 858-mm (SEQ ID NO: 22) 100%, 3A4-mm (SEQ ID NO: 24) 90%, and 3A4-PM (SEQ ID NO: 25) 10%.

FIG. 3A shows a relationship between variation in the fluorescence intensity of TAMRA per unit time (d fluorescence intensity increase/t) and temperature in a Tm analysis of a case of Example 3 using probes: 3T-719-G-PM (SEQ ID NO: 26), 3T-858-G-PM (SEQ ID NO: 27), and 3T-790-T-PM (SEQ ID NO: 28), templates: 719-G (SEQ ID NO: 29) 100%, 858-G (SEQ ID NO: 31) 100%, and 790-T (SEQ ID NO: 33) 100%, and a fluorescent dye: TAMRA. The vertical axis represents the variation in the fluorescence intensity per unit time (d fluorescence intensity increase/t) and the horizontal axis represents temperature (° C.). The drawings below show the results of the same experimentations as above performed by combining with different templates.

FIG. 3B shows the result of Example 3 using templates: 719-G (SEQ ID NO: 29) 50%, 719-C (SEQ ID NO: 30) 50%, 858-G (SEQ ID NO: 31) 100%, and 790-T (SEQ ID NO: 33) 100%.

FIG. 3C shows the result of Example 3 using templates: 719-G (SEQ ID NO: 29) 100%, 858-G (SEQ ID NO: 31) 50%, 858-T (SEQ ID NO: 32) 50%, and 790-T (SEQ ID NO: 33) 100%.

FIG. 3D shows the result of Example 3 using templates: 719-G (SEQ ID NO: 29) 100%, 858-G (SEQ ID NO: 31) 100%, 790-T (SEQ ID NO: 33) 50%, and 790-C (SEQ ID NO: 34) 50%.

FIG. 4A show relationships between variations in the fluorescence intensities of TAMRA, Pacific Blue, and BODIPY FL per unit time (d fluorescence intensity increase/t) and temperatures in a Tm analysis of a case of Example 4 using probes: 3T-719-G-PM (SEQ ID NO: 26), 5PB-V12M-A-PM (SEQ ID NO: 35), 3PB-UGT-T-PM (SEQ ID NO: 36), 5FL-Q126X-T-PM (SEQ ID NO: 37), and 3FL-NAT-C-PM (SEQ ID NO: 38), templates: V12M-PM (SEQ ID NO: 39) 100%, UGT-PM (SEQ ID NO: 41) 100%, Q126X-PM (SEQ ID NO: 43) 100%, NAT-mm (SEQ ID NO: 46) 100%, and 719-mm (SEQ ID NO: 30) 100%, and fluorescent dyes: TAMRA, Pacific Blue, and BODIPY FL. The left chart shows variations in Pacific Blue, the central chart shows variations in BODIPY FL, and the right chart shows variations in TAMRA. The vertical axes represent the variations in the fluorescence intensities per unit time (d fluorescence intensity increase/t) and the horizontal axes represent temperatures (° C.). The drawings below show the results of the same experimentations as above performed by combining with different templates.

FIG. 4B show the results of Example 4 using templates: V12M-PM (SEQ ID NO: 39) 50%, V12M-mm (SEQ ID NO: 40) 50%, UGT-PM (SEQ ID NO: 41) 100%, Q126X-PM (SEQ ID NO: 43) 100%, NAT-mm (SEQ ID NO: 46) 100%, and 719-mm (SEQ ID NO: 30) 100%.

FIG. 4C show the results of Example 4 using templates: V12M-PM (SEQ ID NO: 39) 100%, UGT-PM (SEQ ID NO: 41) 50%, UGT-mm (SEQ ID NO: 42) 50%, Q126X-PM (SEQ ID NO: 43) 100%, NAT-mm (SEQ ID NO: 46) 100%, and 719-mm (SEQ ID NO: 30) 100%.

FIG. 4D show the results of Example 4 using templates: V12M-PM (SEQ ID NO: 39) 100%, UGT-PM (SEQ ID NO: 41) 100%, Q126X-PM (SEQ ID NO: 43) 50%, Q126X-mm (SEQ ID NO: 44) 50%, NAT-mm (SEQ ID NO: 46) 100%, and 719-mm (SEQ ID NO: 30) 100%.

FIG. 4E show the results of Example 4 using templates: V12M-PM (SEQ ID NO: 39) 100%, UGT-PM (SEQ ID NO: 41) 100%, Q126X-PM (SEQ ID NO: 43) 100%, NAT-PM (SEQ ID NO: 45) 50%, NAT-mm (SEQ ID NO: 46) 50%, and 719-mm (SEQ ID NO: 30) 100%.

FIG. 4F show the results of Example 4 using templates: V12M-PM (SEQ ID NO: 39) 100%, UGT-PM (SEQ ID NO: 41) 100%, Q126X-PM (SEQ ID NO: 43) 50%, Q126X-mm (SEQ ID NO: 44) 50%, NAT-mm (SEQ ID NO: 46) 100%, 719-PM (SEQ ID NO: 29) 50%, and 719-mm (SEQ ID NO: 30) 50%.

### MODES FOR CARRYING OUT THE INVENTION

### <1> Nucleotide Polymorphism Detection Method According to Some Embodiments of the Present Invention

A polymorphism detection method according to some embodiments of the present invention may include a method for simultaneously detecting a plurality of nucleotide polymorphisms, comprising detecting a plurality of nucleotide polymorphisms at a single wavelength by using a plurality of oligonucleotides labeled with a fluorescent dye, each of which hybridizes to a region containing each of the plurality of nucleotide polymorphisms, wherein

the fluorescent dyes labeling the plurality of oligonucleotides are the same or close to each other in detection wavelength;

the plurality of oligonucleotides are designed such that Tm values of the plurality of oligonucleotides for each of the sequences of said regions to be hybridized containing a first genotype of the nucleotide polymorphisms are close to each other; and

each of the plurality of oligonucleotides is designed such that Tm value for the sequence of the region to be hybridized containing the first genotype is distant from Tm value for the sequence of said region to be hybridized containing a second genotype by 3° C. or more.

The term Nucleotide Polymorphism used herein means that the type of nucleotides located at a specific position on a gene exists in plural forms, and examples of the nucleotide polymorphism include nucleotide substitution, insertion and deletion of one or more nucleotides.

The term “a plurality of nucleotide polymorphisms” in the present disclosure includes both cases of detecting a plurality of nucleotide polymorphisms in a single gene and detecting a single nucleotide polymorphism in each of a plurality of genes.

The method according to some embodiments of the present invention uses a plurality of oligonucleotides labeled with a fluorescent dye that is the same or close to each other in detection wavelength, each of which hybridizes to a nucleotide polymorphism-containing region.

An exemplary case of using two kinds of oligonucleotides will be now described. Oligonucleotide 1 is hybridized to a first polymorphic region and oligonucleotide 2 is hybridized to a second polymorphic region. A fluorescent dye labeling the oligonucleotide 1 and a fluorescent dye labeling the oligonucleotide 2 are the same or close to each other in detection wavelength.

As used herein, the term “close” in a wavelength refers to being in a wavelength range subjected to interference that affects measurement results upon detection of a fluorescence value. Such a close wavelength range varies depending on the combination of fluorescent dyes, and the difference between detection wavelengths (maximum wavelengths) is, for example, within 200 nm, within 100 nm, within 50 nm, or within 30 nm. Examples of the combination of fluorescent dyes mutually close in detection wavelength as above include BODIPY FL and FAM, BODIPY FL and TRITC, Pacific Blue and Alexa Fluor 405, TAMRA and Alexa Fluor 670, TAMRA and Alexa Fluor 700, and TAMRA and Texas Red. That is, in the method according to some embodiments of the present invention, even when the same fluorescent dye is not necessarily used, labeling each of the oligonucleotides with a fluorescent dye close to each other in detection wavelength allows for the simultaneous detection of a plurality of nucleotide polymorphisms at a single wavelength.

The term “single wavelength” used herein means not only the same wavelength but also the close wavelength range as mentioned above.

The case of having the same detection wavelength usually means that a plurality of oligonucleotides is labeled with the same fluorescent dye.

In the method described herein, as long as the detection of a plurality of nucleotide polymorphisms is performed at a single wavelength, the detection of nucleotide polymorphisms (those different from the plurality of nucleotide polymorphisms) using one or two or more kinds of probes labeled with a fluorescent dye having one or two or more other detection wavelengths (other than and not close to the “single wavelength” to be used for detecting the “plurality of the nucleotide polymorphisms”) may be simultaneously or sequentially performed. That is, as long as a plurality of nucleotide polymorphisms is detected at a single wavelength, the detection of nucleotide polymorphisms at one or two or more other wavelengths may be simultaneously or sequentially performed.

In the method described herein, Tm values of the plurality of oligonucleotides for each of the sequences of the regions to be hybridized containing a first genotype are concentrated in a close region. As used herein, regarding the close temperature region, a difference between the respective Tm values for the first genotype-containing sequences of the plurality of oligonucleotides is, for example, 0 to 4° C., 0 to 2° C., or 0 to 1° C.

Furthermore, each of the plurality of oligonucleotides is designed such that Tm value for the sequence of the region to be hybridized containing the first genotype is distant from Tm value for the sequence of said region to be hybridized containing a second genotype by 3° C. or more, 5° C. or more, or 10° C. or more, for example.

Now, a description will be given of an exemplary case of using two oligonucleotides: oligonucleotide 1 hybridized to a first polymorphic region and oligonucleotide 2 hybridized to a second polymorphic region (alternatively, three or more kinds of oligonucleotides may be used).

The temperature difference between a Tm value of the oligonucleotide 1 for a first genotype (such as a wild type) of the first polymorphic region and a Tm value of the oligonucleotide 2 for the first genotype (such as a wild type) of the second polymorphic region is 0 to 4° C., 0 to 2° C., or 0 to 1° C., for example.

Then, the temperature difference between the Tm value of the oligonucleotide 1 for the first genotype (such as a wild type) of the first polymorphic region and a Tm value of the oligonucleotide 1 for the second genotype (such as a mutant type) of the first polymorphic region is 3° C. or more, 5° C. or more, or 10° C. or more, for example.

Furthermore, the temperature difference between the Tm value of the oligonucleotide 2 for the first genotype (such as a wild type) of the second polymorphic region and a Tm value of the oligonucleotide 2 for a second genotype (such as a mutant type) of the second polymorphic region is 3° C. or more, 5° C. or more, or 10° C. or more, for example.

The temperature difference between the Tm value of the oligonucleotide 1 for the second genotype (such as a mutant type) of the first polymorphic region and the Tm value of the oligonucleotide 2 for the second genotype (such as a mutant type) of the second polymorphic region may be 0° C., but is 1° C. or more to distinguish both mutations, for example.

When the first genotype-containing sequence is a wild-type sequence and the second genotype-containing sequence is a mutant-type sequence having one or more nucleotide substitution mutations, insertion mutations and/or deletion mutations in a wild-type sequence, by setting such that peaks of the wild-type sequence for the plurality of the oligonucleotides are concentrated in a predetermined temperature region, mutant-type sequences may be detected without detection of the peaks of the wild-type sequence.

That is, since Tm values for the wild type are encompassed in the predetermined temperature region, the presence or absence of a mutant type may be detected by detecting a peak shifted from the Tm value of the wild type, which corresponds to the mutant type.

In other words, by concentrating in advance peaks (namely, Tm values) obtained in a melting curve analysis regarding the first genotype-containing sequence in a predetermined temperature region, mutation may be detected by measuring a peak of the second genotype-containing sequence (e.g., as described above, a peak shifted by 3° C. or more from the peak of the first genotype-containing region), without measurement of any peak in the melting curve analysis regarding the first genotype-containing sequence.

For example, desirably, as the oligonucleotides, there may be selected a sequence completely (i.e. 100%) matching with the first genotype (wild type)-containing sequence but including a mismatch with respect to the second genotype (mutant type)-containing sequence, and as described above, the oligonucleotides are designed such that the Tm value for the first genotype-containing sequence is higher than the Tm value for the second genotype-containing equence by 3° C. or more, 5° C. or more, or 10° C. or more, for example.

Alternatively, probe sequences may be selected that include a mismatch with respect to the first genotype (wild type)-containing sequence but completely (i.e. 100%) match with the second genotype (mutant type)-containing sequence and may be designed such that the Tm value for the first genotype-containing sequence is lower than the Tm value for the second genotype-containing sequence by 3° C. or more, 5° C. or more, or 10° C. or more.

The first genotype and the second genotype may be both mutants. When the first genotype-containing sequence and the second genotype-containing sequence are both mutant sequences, detection may also be made as to whether the second genotype-containing sequence includes more mutations than the first genotype-containing sequence.

As the oligonucleotides to be hybridized to the nucleotide polymorphism-containing regions are used in the method described herein, for example, there may be used a quenching probe with fluorescent dye-labeled end(s), as described in JP2001-86300A and JP2002-119291A. In such an oligonucleotide probe, when hybridized to the target sequence, for example, fluorescence of the fluorescent dye decreases or increases as compared to when the probe is not hybridized to a target sequence. The oligonucleotide probe in some embodiments of the present invention may include, for example, a quenching probe in which fluorescence of the fluorescent dye is emitted when the probe is not hybridized, whereas the fluorescence thereof is quenched when it is hybridized.

The length of oligonucleotide probes described herein is not specifically limited, but the probes may be, for example, 40 nucleotides or less in length to obtain the difference of Tm values between the first genotype-containing sequence and the second genotype-containing sequence, and for example, 11 to 40 nucleotides in length, 12 to 30 nucleotides in length, 15 to 30 nucleotides in length, or 18 to 30 nucleotides in length.

Examples of nucleotide sequences of the probes for detecting nucleotide polymorphisms to be used herein include probes shown in SEQ ID NOs: 9 to 11, SEQ ID NOs: 20 to 21, SEQ ID NOs: 26 to 28, and SEQ ID NOs: 35 to 38.

As the fluorescent dyes to be used, there may be mentioned those described in JP2001-286300A, JP2002-119291A, and the like. Specific examples of the fluorescent dyes include Pacific Blue, FAM, TAMRA, and BODIPY FL. The method for binding a fluorescent dye to the oligonucleotides may be performed according to a usual method, such as any of methods described in JP2001-286300A and JP2002-119291A.

The method according to the present disclosure is not specifically limited as long as it is a method using the oligonucleotide probes described herein, and for example, may analyze nucleotide polymorphisms by melting curve analysis.

The method described herein may be performed according to a usual melting curve analysis method (Tm analysis), except that there is used a plurality of oligonucleotides labeled with a fluorescent dye that is the same or close to each other in detection wavelength; the plurality of oligonucleotides are designed such that Tm values for the sequence containing a first genotype of the plurality of nucleotide polymorphisms are close to each other; and each of the plurality of oligonucleotides is designed such that the Tm value for the first genotype-containing sequence is distant from a Tm value for the second genotype-containing sequence by 3° C. or more. The melting curve analysis may be performed, for example, according to methods described in JP2001-286300A and JP2002-119291A.

In the melting curve analysis, when a mutant peak is detected, the presence of a mutation may be concluded.

In addition, the method described herein may include amplifying a nucleic acid before the detection of nucleotide polymorphisms or simultaneously with the detection of nucleotide polymorphisms.

The nucleic acid amplification method is, for example, a method using polymerase, and examples of the method include PCR, ICAN, and LAMP. When amplification is performed using polymerase, for example, amplification is performed in the presence of the probes described herein. According to the probe to be used, it is easy for those skilled in the art to adjust reaction conditions for amplification and the like. Thereby, it is only necessary to analyze the Tm values of probes after amplification of a nucleic acid, so that purification or the like of an amplification product after completion of reaction is unnecessary. Therefore, there is no worry about contamination due to the amplification product. Additionally, since the detection of nucleotide polymorphisms may be performed by the same apparatus as that necessary for amplification, transfer of the container is even not needed, so that process automation may be easily achieved.

In some embodiments, DNA present in a sample may be a single-strand DNA or a double-strand DNA. When the DNA is a double-strand DNA, for example, the method may include a step of separating the double-strand DNA in the sample by heating before the hybridization step. By separating the double-strand DNA into single-strand DNAs, hybridization to the detection probes may be performed in the next hybridization step.

The nucleic acid as a template used upon nucleic acid amplification is not specifically limited as long as it includes nucleic acid, and for example, may be one derived or derivable from arbitrary biological sources such as blood, oral mucosa suspension, a somatic cell such as nail or hair, germ cell, milk, ascitic fluid, paraffin embedded tissue, gastric juice, gastric lavage fluid, peritoneal fluid, amniotic fluid, and cell culture. The nucleic acid as the template may be used directly as it is obtained from any of the sources or after performing pretreatment to alter the properties of the sample.

Tm analysis may be performed according to a usual method, except for measuring fluorescence of the fluorescent dye(s) of the probes used herein. The measurement of fluorescence may be performed by measuring light having a light emission wavelength using excitation light with a wavelength according to the fluorescent dye(s). The rate of temperature rise in Tm analysis is usually 0.1 to 1° C./second. The composition of reaction solution used to perform Tm analysis is not specifically limited as long as it allows for the hybridization of a probe to a nucleic acid having a sequence complementary to a nucleotide sequence of the probe, but usually, the concentration of monovalent cation is 1.5 to 5 mM and pH is 7 to 9. Since the reaction solution for an amplification method using DNA polymerase, such as PCR, meets those conditions, post-amplification reaction solution may be used as it is in Tm analysis.

Detection of nucleotide polymorphisms based on the results of Tm analysis may be performed according to a usual method. Detection described herein includes detection of the presence or absence of mutation and the amount of mutation.

The nucleotide polymorphism detection method described herein may detect nucleotide polymorphism(s) and may determine the presence or absence of nucleotide polymorphism(s) associated with medicinal effect and physical predisposition to predict medicinal effect on an individual and the physical predisposition of the individual. For example, in the case of an EGFR exon 20 insertion polymorphism, the efficacy of gefitinib as an anticancer drug may be determined.

### <2> Kit According to Some Embodiments of the Present Invention

A kit according to the present disclosure may include a kit used for the nucleotide polymorphism detection method described herein.

Specifically, the kit according to some embodiments of the present invention may include a kit for simultaneously detecting a plurality of nucleotide polymorphisms at a single wavelength, comprising nucleotide polymorphism detection probes consisting of a plurality of oligonucleotides labeled with a fluorescent dye that is the same or close to each other in detection wavelength. The kit is characterized in that the plurality of oligonucleotides are designed such that Tm values of the plurality of oligonucleotides for each of the sequences of said regions to be hybridized containing a first genotype of the nucleotide polymorphisms are close to each other; and each of the plurality of oligonucleotides is designed such that Tm value for the sequence of the region to be hybridized containing the first genotype is distant from Tm value for the sequence of said region to be hybridized containing a second genotype by 3° C. or more.

The detection kit according to some embodiments of the present invention may further include, in addition to the above probes, primers for amplification using reagents required to perform nucleic acid amplification, particularly DNA polymerase.

In the detection kit described herein, the probes, the primers, and other reagents may be separately contained or parts thereof may be made into a mixture.

### <3> Apparatus According to Some Embodiments of the Present Invention

An apparatus according to some embodiments of the present invention may include an apparatus used for the nucleotide polymorphism detection method, and specifically, includes a reaction section containing a plurality of oligonucleotides which hybridize to a nucleotide polymorphism-containing region, a liquid sending section feeding a sample and/or reaction solution to the reaction section, a light source section emitting light for exciting fluorescence to the reaction section, a control section controlling temperature of the reaction section, and a detection section detecting the fluorescence. The apparatus is characterized in that, as described in the <1> the nucleotide polymorphisms detection method described herein, the plurality of oligonucleotides are labeled with a fluorescent dye that is the same or close to each other in detection wavelength; the plurality of oligonucleotides are designed such that Tm values of the plurality of oligonucleotides for each of the sequences of said regions to be hybridized containing a first genotype of the nucleotide polymorphisms are close to each other; and each of the plurality of oligonucleotides is designed such that Tm value for the sequence of the region to be hybridized containing the first genotype is distant from Tm value for the sequence of said region to be hybridized containing a second genotype by 3° C. or more.

In the reaction section, the plurality of oligonucleotides may be fixed or a substrate with the plurality of oligonucleotides fixed thereon may be set immediately before its use.

The liquid sending section may simultaneously or separately send a gene-containing sample and a reaction solution. In addition, the liquid sending section may be adapted such that cleansing liquid may be sent.

The light source section may be any as long as it is a light source capable of emitting light having an excitation wavelength corresponding to the oligonucleotide-labeling fluorescent dye. When simultaneously or sequentially performing the detection of nucleotide polymorphisms (those different from the plurality of nucleotide polymorphisms) using one or two or more kinds of probes labeled with a fluorescent dye having one or two or more other detection wavelengths (other than and not close to the “single wavelength” to be used for detecting the “plurality of the nucleotide polymorphisms”), one or two or more kinds of light sources capable of emitting light having other excitation wavelength(s) may be combined.

For example, the control section may increase or decrease the temperature of the reaction section at a predetermined rate and also may maintain it at a predetermined temperature.

The detection section may be any as long as it may detect at the same or close detection wavelength corresponding to the fluorescent dye labeling the oligonucleotides. When simultaneously or sequentially performing the detection of nucleotide polymorphisms (those different from the plurality of nucleotide polymorphisms) using one or two or more kinds of probes labeled with a fluorescent dye having one or two or more other detection wavelengths (other than and not close to the “single wavelength” to be used for detecting the “plurality of the nucleotide polymorphisms”), the other detection wavelengths may be detected. In addition, only the second genotype may be assigned as a detection target and only the peak of a second genotype-containing sequence (for example, a peak shifted from the peak of a first genotype-containing sequence by 3° C. or more) may be detected.

<4> System according to Some Embodiments of the Present Invention

A system according to some embodiments of the present invention may include a system used for a nucleotide polymorphism detection method, and may specifically include a reaction system that contains a plurality of oligonucleotides which hybridize to a nucleotide polymorphism-containing region, a liquid sending system that feeds a reagent and/or reaction solution to the reaction system, a light source section that emits light for exciting fluorescence to the reaction system, a control section that controls temperature of the reaction system, a detection section that detects fluorescence, and a determination system that determines a nucleotide polymorphism based on a detection result. In some embodiments, as described in the <1> the nucleotide polymorphism detection method , the plurality of oligonucleotides may be labeled with a fluorescent dye that is the same or close to each other in detection wavelength; the plurality of oligonucleotides are designed such that Tm values of the plurality of oligonucleotides for each of the sequences of said regions to be hybridized containing a first genotype of the nucleotide polymorphisms are close to each other; and each of the plurality of oligonucleotides is designed such that Tm value for the sequence of the region to be hybridized containing the first genotype is distant from Tm value for the sequence of said region to be hybridized containing a second genotype by 3° C. or more.

For the reaction system, the liquid sending system, the light source system, the control system, and the detection system, the apparatus described herein may be used. In addition, the determination system may be like a computer connected to the apparatus according to some embodiments of the present invention to output a determination as to the type of nucleotide polymorphism, the presence or absence of mutation, and the like from input detection results.

### EXAMPLES

Hereinafter, some embodiments of the present invention will be described in detail with reference to Examples, but the invention disclosed herein is not limited to the following Examples.

### Example 1

### Detection of Template Oligonucleotides with EGFR Exon 20 Insertion by Three Kinds of Probes at Two Wavelengths

Regarding EGFR exon 20 insertion, besides a wild type (hereinafter referred to as WT), the following seven extensive mutations are known. Since the efficacy rate of gefitinib on patients with EGFR exon 20 insertion mutations is said to be 0%, it is necessary to detect an EGFR exon 20 insertion mutant type (hereinafter referred to as mt).

The sequence shown in SEQ ID NO: 1 represents nucleotide numbers 2530-2579 in NM_{—}005228.3 GENE ID: 1956.

TABLE 1

| | Name | Sequence (5′→3′) | SEQ ID NO. |
|---|---|---|---|
| WT | EGFR-e20-ins- | Gaagcctacgtgatggccagcgtggacaacccccacgtgtgccgcctgct | SEQ ID |
| | WT-F | | NO: 1 |
| mt1 | EGFR-e20- | gaagcctacgtgatggccagcgtgGCCAGCGTGgacaacccccacgtgtgccgcctgct | SEQ ID |
| | ins9-F | | NO: 2 |
| mt2 | EGFR-e20- | gaagcctacgtgatggccagcgtggacaacccccacCACgtgtgccgcctgct | SEQ ID |
| | insCAC-F | | NO: 3 |
| mt3 | EGFR-e20- | gaagcctacgtgatggccagcgtgTGCGTGgacaacccccacgtgtgccgcctgct | SEQ ID |
| | insTGCGTG-F | | NO: 4 |
| mt4 | EGFR-e20- | gaagcctacgtgatggccagcgtggacaaccccAACCCCcacgtgtgccgcctgct | SEQ ID |
| | insAACCCC-F | | NO: 5 |
| mt5 | EGFR-e20- | gaagcctacgtgatggccagcgtggacaacccccacCCCCACgtgtgccgcctgct | SEQ ID |
| | insCCCCAC-F | | NO: 6 |
| mt6 | EGFR-e20- | gaagcctacgtgatggccagcgtggacaacccccacAACCCCCACgtgtgccgcctgct | SEQ ID |
| | insAACCCCCAC- | | NO: 7 |
| | F | | |
| mt7 | EGFR-e20- | gaagcctacgtgatggccagcgtggacaacccccacgtgCACGTGtgccgcctgct | SEQ ID |
| | insCACGTG-F | | NO: 8 |

* Nucleotides indicated by capital letters represent mutation spots.

To cover all mt types using a method described in JP2002-355084A, it is necessary to use long probes of approximately 40 by in length, but, in this manner, a Tm value difference may not be obtained and thus mutation detection may be disabled. Accordingly, there were prepared some probes perfectly matching with a WT and having the same Tm value as that of the WT, and fluorophores of the probes were made so as to have the same wavelength.

Based on a nucleotide sequence (SEQ ID NO: 1 (wild type)) containing an EGFR exon 20 insertion polymorphism site, there were designed probes having C at its 3′ end (wild type: SEQ ID NOs: 9 and 10) and (mutant type: SEQ ID NO: 11), as shown in Table 2 as below. In Table 2, the position of probe represents nucleotide numbers in the nucleotide sequence shown in SEQ ID NO: 1 regarding SEQ ID NOs: 9 and 10, and regarding SEQ ID NO: 11, it represents nucleotide numbers in the nucleotide sequence shown in SEQ ID NO: 7. Labeling with Pacific Blue or BODIPY FL was performed according to a usual method.

Additionally, Table 2 shows the sequences of a template oligonucleotide (a wild type antisense (SEQ ID NO: 12) and mutant type antisense oligonucleotides (SEQ ID NOs: 13 to 19) used as detection targets. The sequences shown in SEQ ID NOs: 12 to 19, respectively, are the complete complementary strands of SEQ ID NOs: 1 to 8, respectively.

The probe of SEQ ID NO: 9 may detect mtl and mt3 of Table 1; the probe of SEQ ID NO: 10 may detect mt2, mt4, mt5, and mt7 of Table 1; and the probe of SEQ ID NO: 11 may detect mt6 of Table 1.

TABLE 2

| SEQ ID NO. | Name of probe | Sequence (5′→3′) | Position |
|---|---|---|---|
| SEQ ID | 3PB-EGFR-insWT- | tgtccacgctggccatc- | 28-12 |
| NO: 9 | R5 | (Pacific Blue) | |
| SEQ ID | 3PB-EGFR-insWT- | ggacaacccccacgtgtgc- | 24-42 |
| NO: 10 | F4 | (Pacific Blue) | |
| SEQ ID | 3FL-EGFR-ins7- | acaacccccacAACCCCCAC- | 26-45 |
| NO: 11 | F1 | (FL) | |

* Nucleotides indicated by capital letters represent mutation spots.

| SEQ ID | | | |
|---|---|---|---|
| NO. | | Name of template oligo | Sequence (5′→3′) |
| SEQ ID | WT | EGFR-e20-ins-WT-R1 | agcaggcggcacacgtgggggttgt |
| NO: 12 | | | ccacgctggccatcacgtaggcttc |
| SEQ ID | 1 | EGFR-e20-ins9-R2 | agcaggcggcacacgtgggggttgt |
| NO: 13 | | | ccacgctggccacgctggccatcac |
| | | | gtaggcttc |
| SEQ ID | 2 | EGFR-e20-insCAC-R3 | agcaggcggcacacgtggtgggggt |
| NO: 14 | | | tgtccacgctggccatcacgtaggc |
| | | | ttc |
| SEQ ID | 3 | EGFR-e20-insTGCGTG-R5 | agcaggcggcacacgtgggggttgt |
| NO: 15 | | | ccacgcacacgctggccatcacgta |
| | | | ggcttc |
| SEQ ID | 4 | EGFR-e20-insAACCCC-R6 | agcaggcggcacacgtgggggttgg |
| NO: 16 | | | ggttgtccacgctggccatcacgta |
| | | | ggcttc |
| SEQ ID | 5 | EGFR-e20-insCCCCAC-R7 | agcaggcggcacacgtgggggtggg |
| NO: 17 | | | ggttgtccacgctggccatcacgta |
| | | | ggcttc |
| SEQ ID | 6 | EGFR-e20-insAACCCCCAC- | agcaggcggcacacgtgggggttgt |
| NO: 18 | | R8 | gggggttgtccacgctggccatcac |
| | | | gtaggcttc |
| SEQ ID | 7 | EGFR-e20-insCACGTG-R9 | agcaggcggcacacgtgcacgtggg |
| NO: 19 | | | ggttgtccacgctggccatcacgta |
| | | | ggcttc |

Tm analysis was performed using a full automatic SNPs analyzer (product name: i-densy IS-5310 manufactured by ARKRAY, Inc.). Also in the following Tm analysis, the same analyzer was used unless specifically stated otherwise. The composition of the probe solution is as shown below. Samples used were template oligonucleotides as below. Conditions for the Tm analysis were set to: 95° C., 1 sec.→40° C., 60 sec.→(40° C.→85° C., 1° C./3 sec.).

Excitation wavelengths and detection wavelengths, respectively, in the Tm analysis were set to 365 to 415 nm and 445 to 480 nm (Pacific Blue), respectively, or 420 to 485 nm and 520 to 555 nm (BODIPY FL), respectively.

TABLE 3

| Amount of reaction solution (10 μl) | |
|---|---|
| 1 × PCR Buffer | |
| 3PB-EGFR-insWT-R5 | 0.2 μM |
| 3PB-EGFR-insWT-F4 | 0.2 μM |
| 3FL-EGFR-ins7-F1 | 0.2 μM |
| Template oligonucleotide | 0.2 μM |

| Measurement ID | Template oligonucleotide | SEQ ID NO. |
|---|---|---|
| 1 | WT | SEQ ID NO: 1 |
| 2 | mt 1 | SEQ ID NO: 2 |
| 3 | mt 2 | SEQ ID NO: 14 |
| 4 | mt 3 | SEQ ID NO: 4 |
| 5 | mt 4 | SEQ ID NO: 16 |
| 6 | mt 5 | SEQ ID NO: 17 |
| 7 | mt 6 | SEQ ID NO: 18 |
| 8 | mt 7 | SEQ ID NO: 19 |

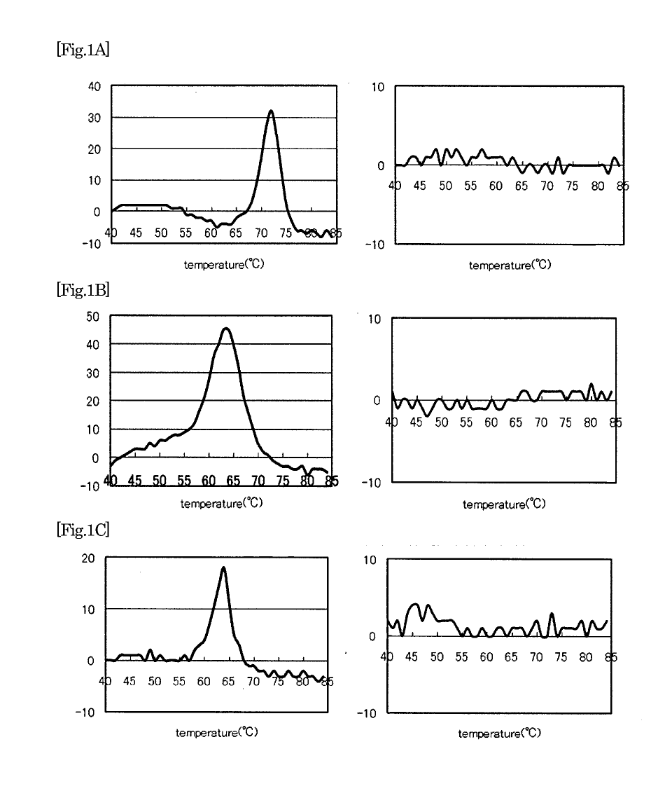

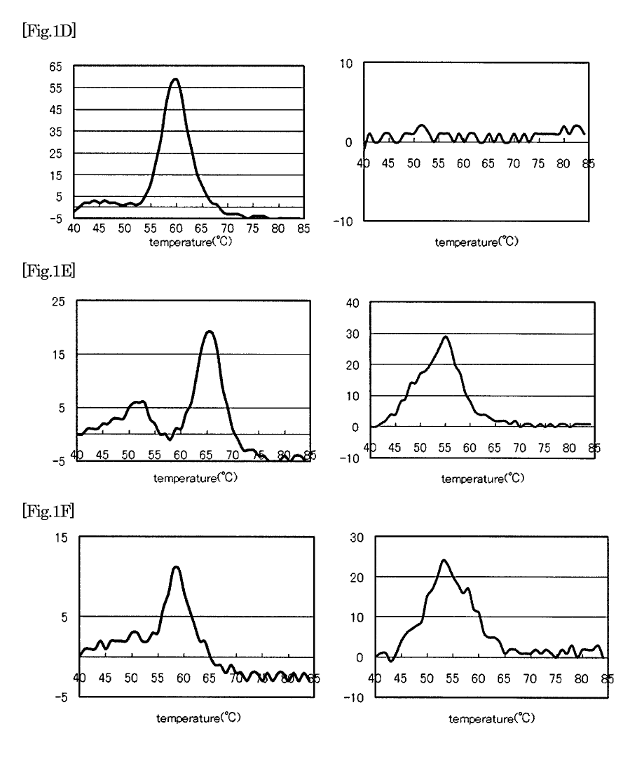

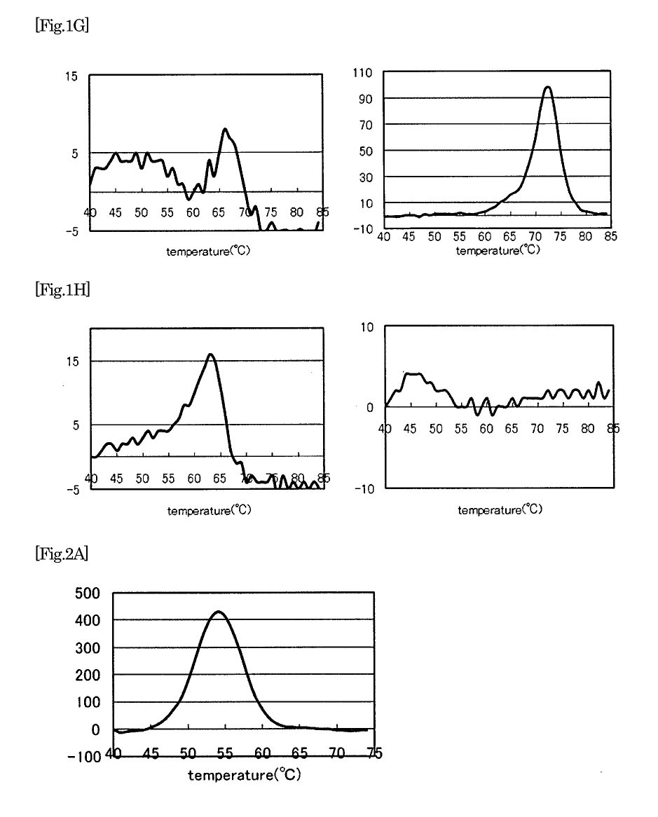

As the results of the Tm analysis using the probes of Table 2 and the template oligonucleotides of Table 3, clear mutant peaks of Pacific Blue were observed in WT, mtl, mt2, mt3, mt4, mt5, and mt7 (left charts of FIGS. 1A, 1B, 1C, 1D, 1E, 1F, and 1H), whereas no mutant peak of Pacific Blue was observed in mt6 (left chart of FIG. 1G). In addition, mt6 exhibited mutant peaks of BODIPY FL (right chart of FIG. 1G), whereas WT, mt 1, mt 2, mt 3, mt 4, mt 5, and mt 7 exhibited no clear mutant peak of BODIPY FL (right charts of FIGS. 1A, 1B, 1C, 1D, 1E, 1F, and 1H).

In other words, in all of the mt1 to mt7, peaks different from the wild-type peak (72° C.) were able to be detected, so that the detection of mutations of mt1 to mt7 is thought to be possible.

Table 4 below shows the results.

TABLE 4

| Measurement ID | | PB probe (Tm) | FL probe (Tm) |
|---|---|---|---|
| 1 | WT | 72 | |
| 2 | mt1 | 64 | |
| 3 | mt2 | 64 | |
| 4 | mt3 | 60 | |
| 5 | mt4 | 66 | |
| 6 | mt5 | 59 | |
| 7 | mt6 | | 73 |
| 8 | mt7 | 63 | |

From the above, using the two kinds of probes: 3PB-EGFR-insWT-R5 and 3PB-EGFR-insWT-F4, the plurality of mutations were able to be detected at a single wavelength: 445 to 480 nm. Then, by combining with 3FL-EGFR-ins7-F1, all EGFR exon 20 insertion mutations were able to be detected.

### Example 2

### Detection of Template Oligonucleotides of Two Different Kinds of Genes Using Two Kinds of Probes at a Single Wavelength

As shown in Table 5, there was designed a probe (corresponding to 3PB-858-G-PM (SEQ ID NO: 20) having a sequence complementary to the nucleotide sequence of SEQ ID NO: 23 and having C at its end. In Table 5, the position of the probe represents nucleotide numbers in the nucleotide sequence shown in SEQ ID NO: 23. There were also designed a perfect matching type, which will be hereinafter referred to as PM type (SEQ ID NO: 23) as a template oligonucleotide used as a detection target, and a mismatching type, which will be hereinafter referred to as mm type (SEQ ID NO: 22) as a non-detection target.

In addition, as shown in Table 5, there was designed a probe (corresponding to 3PB-3A4-G-PM (SEQ ID NO: 21) having a sequence complementary to the nucleotide sequence of SEQ ID NO: 25 and having C at its end. In Table 5, the position of the probe represents nucleotide numbers in the nucleotide sequence shown in SEQ ID NO: 25. There were also designed a PM type (SEQ ID NO: 25) as a template oligonucleotide used as a detection target and an mm type (SEQ ID NO: 24) as a non-detection target.

TABLE 5

| SEQ ID NO. | Name of probe | Sequence (5′ → 3′) | Position |
|---|---|---|---|
| SEQ ID NO: 20 | 3PB-858-G-PM | ttggccCgcccaaaatc-(Pacific Blue) | 27-10 |
| SEQ ID NO: 21 | 3PB-3A4-G-PM | taaatcgccgctctcCtgccc- | 34-15 |
| | | (Pacific Blue) | |

| | Name of template | |
|---|---|---|
| SEQ ID NO. | oligo | Sequence (5′ → 3′) |
| SEQ ID NO: 22 | 858-mm | caagatcacagattttgggcTggccaaactgctgg |
| | | gtgcggaagagaaag |
| SEQ ID NO: 23 | 858-PM | caagatcacagattttgggcGggccaaactgctgg |
| | | gtgcggaagagaaag |
| SEQ ID NO: 24 | 3A4-mm | agccatagagacaagggcaAgagagaggcgatttaataga |
| SEQ ID NO: 25 | 3A4-PM | agccatagagacaagggcaGgagagaggcgatttaataga |

* Nucleotides indicated by capital letters represent mutation spots.
* Nucleotides indicated by capital letters represent mutation spots.

The composition of the PCR reaction solution is as shown below. The samples used were the combinations of template oligonucleotides as below. Conditions for the Tm analysis were set to: 95° C., 1 sec.→40° C., 60 sec.→(40° C.→75° C., 30° C./1 sec.).

Excitation wavelengths and detection wavelengths, respectively, in the Tm analysis were set to 365 to 415 nm and 445 to 480 nm (Pacific Blue), respectively.

TABLE 6

| Amount of reaction solution (50 μl) | |
|---|---|
| 1 × PCR Buffer | |
| 3PB-858-G-PM | 0.2 μM |
| 3PB-3A4-G-PM | 0.2 μM |
| Template oligonucleotide | 0.2 μM for each |

| | | | | Tm |
|---|---|---|---|---|
| Measurement | | Template | | value |
| ID | Conditions | oligonucleotide | | (° C.) |
| 1 | 858-mm, | SEQ ID | SEQ ID | 55 |
| | 3A4-mm | NO: 22 100% | NO: 24 100% | |
| 2 | 858-PM 50%, | SEQ ID | SEQ ID | 55/64 |
| | 3A4-mm | NO: 22 50% | NO: 24 100% | |
| | | SEQ ID | | |
| | | NO: 23 50% | | |
| 3 | 858-PM 10%, | SEQ ID | SEQ ID | 55/64 |
| | 3A4-mm | NO: 22 90% | NO: 24 100% | |
| | | SEQ ID | | |
| | | NO: 23 10% | | |
| 4 | 858-mm, | SEQ ID | SEQ ID | 55/65 |
| | 3A4-PM 50% | NO: 22 100% | NO: 24 50% | |
| | | | SEQ ID | |
| | | | NO: 25 50% | |
| 5 | 858-mm, | SEQ ID | SEQ ID | 55/65 |
| | 3A4-PM 10% | NO: 22 100% | NO: 24 90% | |
| | | | SEQ ID | |
| | | | NO: 25 10% | |

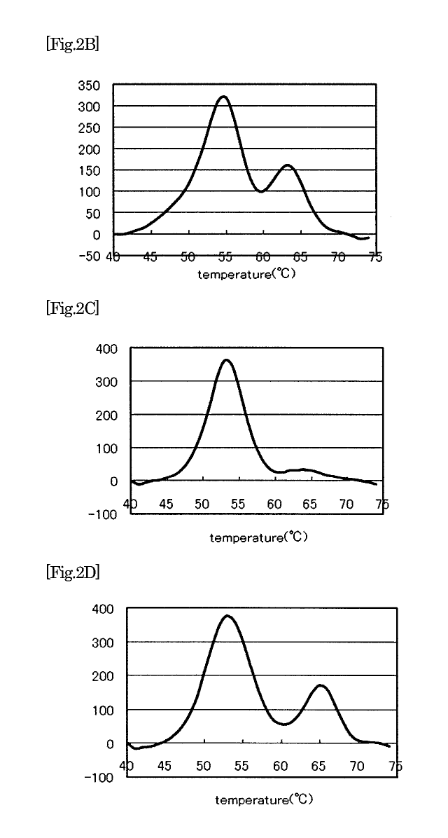

As the results of the Tm analysis using the probes of Table 5, regardless of the cases including 50% of the nucleotide sequences (SEQ ID NOs: 23 and 25) as the detection targets (FIGS. 2B and 2D) and 10% thereof (FIGS. 2C and 2E), clear PM-type peaks, in addition to mm-type peaks, were observed.

In other words, in any case, the peaks different from the mm-type peaks (55° C.) were able to be detected, so that detection of the PM types as the detection targets at a sensitivity of 10% is thought to be possible.

### Example 3

### Detection of Template Oligonucleotides of Three Different Kinds of Genes Using Three Kinds of Probes at a Single Wavelength

As shown in Table 7, there were designed probes (corresponding to 3T-719-G-PM, 3T-858-G-PM, and 3T-790-T-PM (SEQ ID NOs: 26 to 28)) having complementary sequences to three nucleotide sequences (SEQ ID NOs: 29, 31, and 33) and having C at 3′ ends thereof In Table 7, the positions of the probes each represent nucleotide numbers in the nucleotide sequence shown in each of SEQ ID NOs: 29, 31, and 33. In addition, there were designed mm types (SEQ ID NOs: 30, 32, and 34) as template oligonucleotides used as detection targets and PM types (SEQ ID NOs: 29, 31, and 33) as non-detection targets.

TABLE 7

| SEQ ID NO. | Name of probe | Sequence (5′ → 3′) | Position |
|---|---|---|---|
| SEQ ID NO: 26 | 3T-719-G-PM | gcaccggagCccagcac-(TAMRA) | 34-19 |
| SEQ ID NO: 27 | 3T-858-G-PM | ttggccCgcccaaaatc-(TAMRA) | 27-10 |
| SEQ ID NO: 28 | 3T-790-T-PM | tgagctgcAtgatgaggtgcac- | 25-14 |
| | | (TAMRA) | |

| | Name of | |
|---|---|---|
| SEQ ID NO. | template oligo | Sequence (5′ → 3′) |
| SEQ ID NO: | 719-G | gaattcaaaaagatcaaagtgctggGctccggtgcgttcggcacggtgta |
| 29 | | |
| SEQ ID NO: | 719-C | gaattcaaaaagatcaaagtgctggCctccggtgcgttcggcacggtgta |
| 30 | | |
| SEQ ID NO: | 858-G | caagatcacagattttgggcGggccaaactgctgggtgcggaagagaaag |
| 31 | | |
| SEQ ID NO: | 858-T | caagatcacagattttgggcTggccaaactgctgggtgcggaagagaaag |
| 32 | | |
| SEQ ID NO: | 790-T | cctcacctccaccgtgcagctcatcaTgcagctcatgcccttcggctgcc |
| 33 | | |
| SEQ ID NO: | 790-C | cctcacctccaccgtgcagctcatcaCgcagctcatgcccttcggctgcc |
| 34 | | |

* Nucleotides indicated by capital letters represent mutation spots.
* Nucleotides indicated by capital letters represent mutation spots.

The composition of the PCR reaction solution is as shown below. The samples used were combinations of template oligonucleotides as below. Conditions for the Tm analysis were set to: 95° C., 1 sec.→40° C., 60 sec.→(40° C.→75° C., 30° C./1 sec.).

Excitation wavelengths and detection wavelengths, respectively, in the Tm analysis were set to 520 to 555 nm and 585 to 700 nm (TAMRA), respectively.

TABLE 8

| Amount of reaction solution (50 μl) | |
|---|---|
| 1 × PCR Buffer | |
| 3T-719-G-PM | 0.2 μM |
| 3T-858-G-PM | 0.2 μM |
| 3T-790-T-PM | 0.2 μM |
| Template oligonucleotide | 0.2 μM for each |

| | | | | | Tm |
|---|---|---|---|---|---|
| Measurement | | | | | value |
| ID | Conditions | Template oligonucleotide | | | (° C.) |
| 1 | 719-PM, 858- | SEQ ID NO: 29 | SEQ ID NO: 31 | SEQ ID NO: 33 | 66 |
| | PM, 790-PM | 100% | 100% | 100% | |
| 2 | 719-Ht, 858- | SEQ ID NO: 29 | SEQ ID NO: 31 | SEQ ID NO: 33 | 65/57 |
| | PM, | 50% | 100% | 100% | |
| | 790-PM | SEQ ID NO: 30 | | | |
| | | 50% | | | |
| 3 | 719-PM, 858- | SEQ ID NO: 29 | SEQ ID NO: 31 | SEQ ID NO: 33 | 65/59 |
| | Ht, | 100% | 50% | 100% | |
| | 790-PM | | SEQ ID NO: 32 | | |
| | | | 50% | | |
| 4 | 719-PM, 858- | SEQ ID NO: 29 | SEQ ID NO: 31 | SEQ ID NO: 33 | 65/53 |
| | PM, | 100% | 100% | 50% | |
| | 790-Ht | | | SEQ ID NO: 34 | |
| | | | | 50% | |

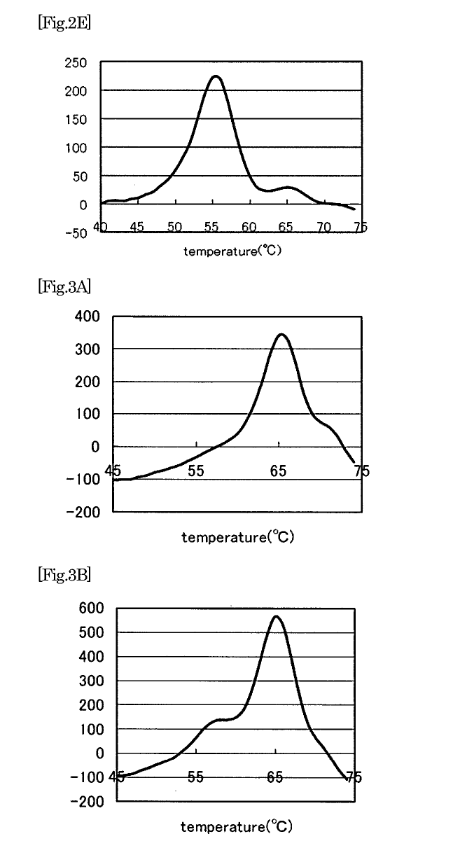

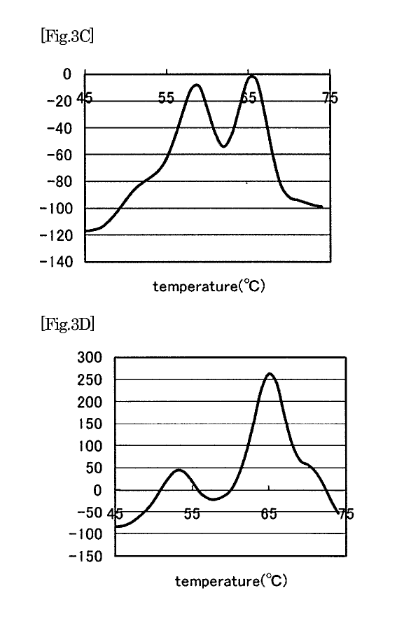

As the results of the Tm analysis using the probes of Table 7, in the case of including 50% of nucleotide sequences (SEQ ID NOs: 30, 32, and 34) as the detection targets (FIGS. 3B, 3C, and 3D), clear mm-type peaks in addition to PM-type peaks were observed.

In other words, in any case, the peaks different from the wild-type peak (65 to 66° C.) were able to be detected, so that detection of the three different kinds of polymorphisms is thought to be possible.

### Example 4

### Detection of Template Oligonucleotides of Five Different Kinds of Genes Using Five Kinds of Probes at Three Wavelengths

As shown in Table 9, there were designed probes (corresponding to 3T-719-G-PM, 5PB-V12M-A-PM, 3PB-UGT-T-PM, 5FL-Q126X-T-PM, and 3FL-NAT-C-PM (SEQ ID NOs: 26, and 35 to 38)) having sequences complementary to five nucleotide sequences (SEQ ID NOs: 29, 39, 41, 43, and 45) and having C at their end. In Table 9, the positions of the probes each represent nucleotide numbers in the nucleotide sequences shown in SEQ ID NOs: 29, 39, 41, 43, and 45. There were also designed PM types (SEQ ID NOs: 39, 41, and 43) and mm types (SEQ ID NOs: 30 and 46) as template oligonucleotides used as detection targets, and mm types (SEQ ID NOs: 40, 42, and 44) and PM types (SEQ ID NOs: 29 and 45) as non-detection targets.

TABLE 9

| SEQ ID NO. | Name of probe | Sequence(5′ → 3′) | Position |
|---|---|---|---|
| SEQ ID NO: 26 | 3 T-719-G-PM | gcaccggagCccagcac-(TAMRA) | 34-18 |
| SEQ ID NO: 35 | 5PB-V12M-A-PM | (PB)-ccttgtgacaTtggga-(P) | 36-21 |
| SEQ ID NO: 36 | 3PB-UGT-T-PM | gagacAgagcattttacac-(PB) | 25-7 |
| SEQ ID NO: 37 | 5FL-Q126X-T-PM | (FL)-cccacttatacttacttAtaccac-(P) | 43-20 |
| SEQ ID NO: 38 | 3FL-NAT-C-PM | tgccgtcaGtggtcac-(FL) | 29-14 |

| | Name of | |
|---|---|---|
| | template | |
| SEQ ID NO. | oligo | Sequence (5′ → 3′) |
| SEQ ID NO: 29 | 719-PM | gaattcaaaaagatcaaagtgctggGctccggtgcgttcggcacggtgta |
| SEQ ID NO: 30 | 719-mm | gaattcaaaaagatcaaagtgctggCctccggtgcgttcggcacggtgta |
| SEQ ID NO: 39 | V12M-PM | cagtaatgtcgaagtttttatcccaAtgtcacaaggaaacaccaatggct |
| SEQ ID NO: 40 | V12M-mm | cagtaatgtcgaagtttttatcccaGtgtcacaaggaaacaccaatggct |
| SEQ ID NO: 41 | UGT-PM | ttcaaggtgtaaaatgctcTgtctctgatgtacaacgagg |
| SEQ ID NO: 42 | UGT-mm | ttcaaggtgtaaaatgctcCgtctctgatgtacaacgagg |
| SEQ ID NO: 43 | Q126X-PM | caaatgtaattcaggttacgtggtaTaagtaagtattagtgggtttgcat |
| SEQ ID NO: 44 | Q126X-mm | caaatgtaattcaggttacgtggtaCaagtaagtattagtgggtttgcat |
| SEQ ID NO: 45 | NAT-PM | ccttctcctgcaggtgaccaCtgacggcaggaattacatt |
| SEQ ID NO: 46 | NAT-mm | ccttctcctgcaggtgaccaTtgacggcaggaattacatt |

* Nucleotides indicated by capital letters represent mutation spots.
* Nucleotides indicated by capital letters represent mutation spots.

The composition of the PCR reaction solution is as shown below. The samples used were combinations of template oligonucleotides as below. Conditions for the Tm analysis were set to: 95° C., 1 sec.→40° C., 60 sec.→(40° C.→85° C., 30° C./1 sec.).

Excitation wavelengths and detection wavelengths, respectively, in the Tm analysis were set to 365 to 415 nm and 445 to 480 nm (Pacific Blue), respectively, 420 to 485 nm and 520 to 555 nm (BODIPY FL), respectively, or 520 to 555 nm and 585 to 700 nm (TAMRA), respectively.

TABLE 10

| Amount of reaction solution (50 μl) | |
|---|---|
| 1 × PCR Buffer | |
| 3T-719-G-PM | 0.2 μM |
| 5PB-V12M-A-PM | 0.2 μM |
| 3PB-UGT-T-PM | 0.2 μM |
| 5FL-Q126X-T-PM | 0.2 μM |
| 3FL-NAT-C-PM | 0.2 μM |
| Template oligonucleotide | 0.2 μM for each |

| | | | | | | Tm value (° C.) | | |
|---|---|---|---|---|---|---|---|---|
| | PB | | FL | | TAMRA | PB | FL | TAMRA |
| 1 | 39 | 41 | 43 | 46 | 30 | near | 54 | 57 |
| | 100% | 100% | 100% | 100% | 100% | 57 | | |
| 2 | 39 | 41 | 43 | 46 | 30 | near | 54 | 57 |
| | 50% | 100% | 100% | 100% | 100% | 49/57 | | |
| | 40 | | | | | | | |
| | 50% | | | | | | | |
| 3 | 39 | 41 | 43 | 46 | 30 | near | 54 | 57 |
| | 100% | 50% | 100% | 100% | 100% | 52/57 | | |
| | | 42 | | | | | | |
| | | 50% | | | | | | |
| 4 | 39 | 41 | 43 | 46 | 30 | near | 47/54 | 57 |
| | 100% | 100% | 50% | 100% | 100% | 57 | | |
| | | | 44 | | | | | |
| | | | 50% | | | | | |
| 5 | 39 | 41 | 43 | 45 | 30 | near | 54/64 | 57 |
| | 100% | 100% | 100% | 50% | 100% | 57 | | |
| | | | | 46 | | | | |
| | | | | 50% | | | | |
| 6 | 39 | 41 | 43 | 46 | 29 | near | 54 | 57/69 |
| | 100% | 100% | 100% | 100% | 50% | 57 | | |
| | | | | | 30 | | | |
| | | | | | 50% | | | |

*The numbers of 29, 30, 39 to 46 in the Table indicate SEQ ID NOs.

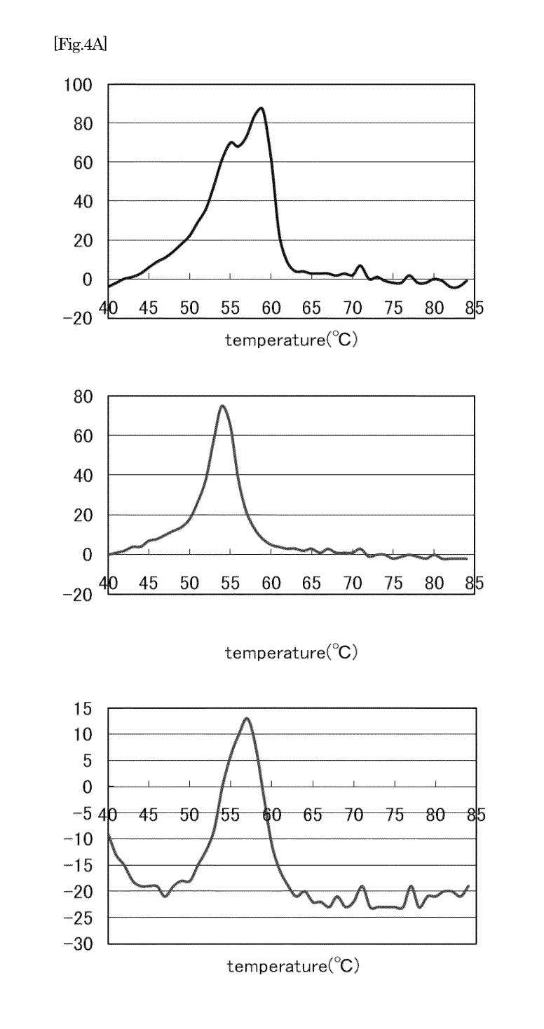

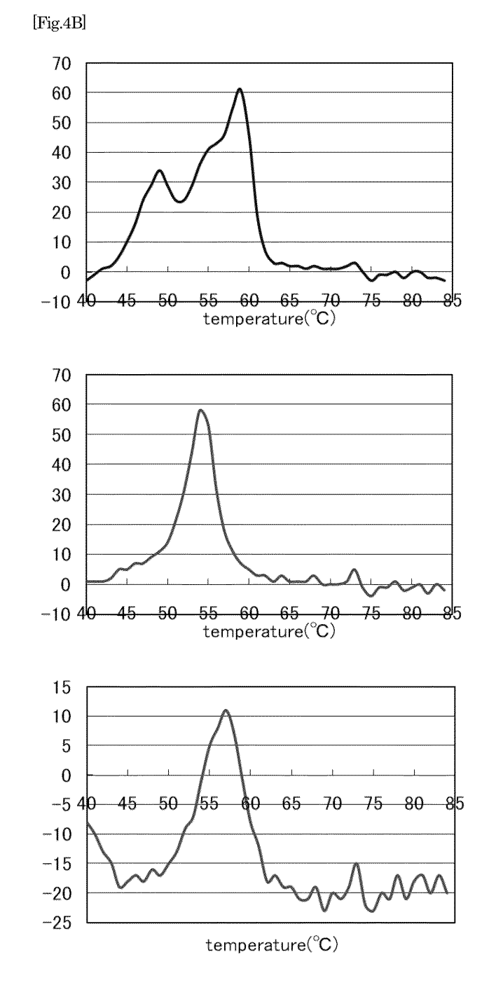

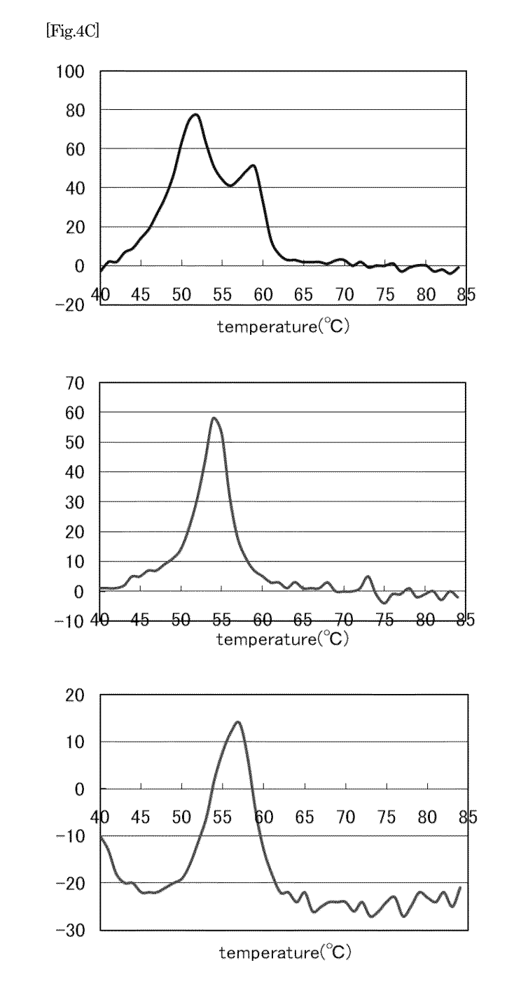

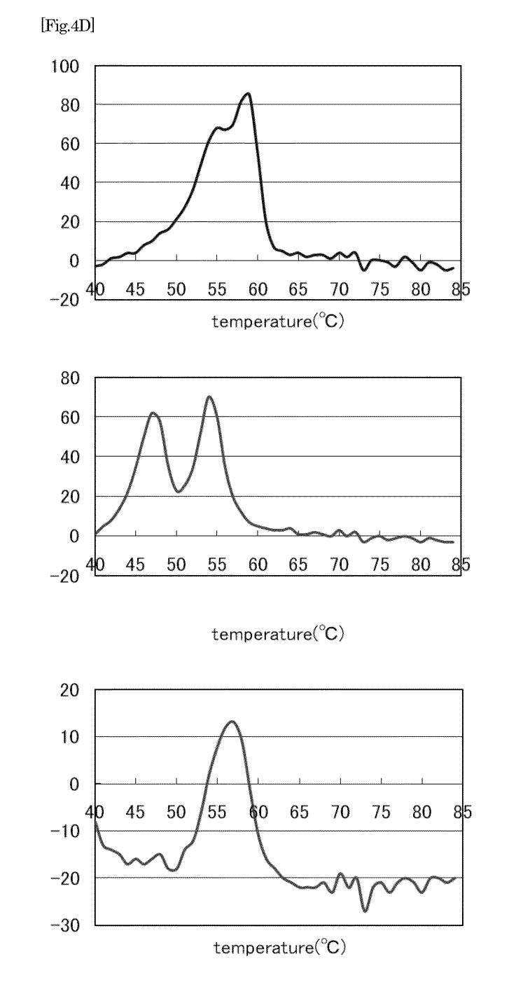

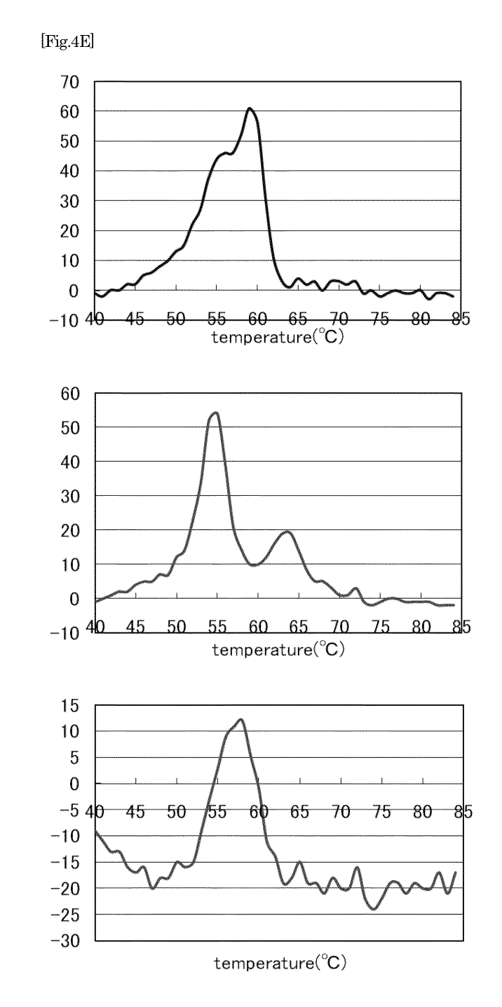

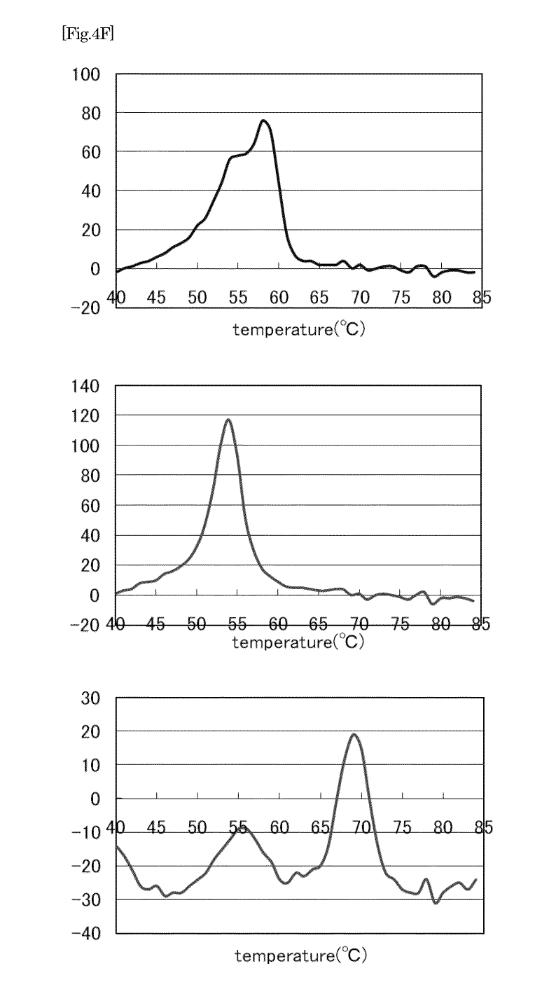

As the results of the Tm analysis performed using the probes of Table 9, regarding Pacific Blue, new peaks were detected only when having the oligonucleotides of SEQ ID NOs: 40 and 42 (left charts of FIGS. 4B and 4C) and the samples without the oligonucleotides of SEQ ID NOs: 40 and 42 had only two peaks (left charts of FIGS. 4A, 4D, 4E, 4F).

Regarding BODIPY FL, new peaks were detected only when having the oligonucleotides of SEQ ID NOs: 44 and 45 (center charts of FIGS. 4D and 4E), and regarding the samples without the oligonucleotides of SEQ ID NOs: 44 and 45, only one peak was observed (center charts of FIGS. 4A, 4B, 4C, and 4F).

Regarding TAMRA, a new peak was detected only when having the oligonucleotide of SEQ ID NO: 29 (right chart of FIG. 4F), and regarding the samples without the oligonucleotide of SEQ ID NO: 29, only one peak was observed (right charts of FIGS. 4A to 4E).

From the above, using the two kinds of probes: 5PB-V12M-A-PM and 3PB-UGT-T-PM, the two kinds of oligonucleotides (SEQ ID NOs: 40 and 42) were able to be detected at the single detection wavelength of 445 to 480 nm. Additionally, using the two probes: 5FL-Q126X-T-PM and 3FL-NAT-C-PM, mutations of the two kinds of oligonucleotides (SEQ ID NOs: 44 and 45) were able to be detected at the single detection wavelength of 520 to 555 nm. Then, by combining with 3T-719-G-PM, all five kinds of mutations were able to be detected.

1. A method for simultaneously detecting a plurality of nucleotide polymorphisms, comprising detecting a plurality of nucleotide polymorphisms at a single wavelength by using a plurality of oligonucleotides labeled with a fluorescent dye, each of which hybridizes to a region containing each of the plurality of nucleotide polymorphisms, wherein
a difference between detection wavelengths of the fluorescent dyes labeling the plurality of oligonucleotides is 200 nm or less;
a difference between Tm values of the plurality of oligonucleotides for each of the sequences of said regions to be hybridized containing a first genotype of the nucleotide polymorphisms is 4° C. or less; and
Tm value for the sequence of the region to be hybridized containing the first genotype is distant from Tm value for the sequence of said region to be hybridized containing a second genotype by 3° C. or more.

2. The method according to claim 1, wherein the difference between the detection wavelengths of the dyes labeling the plurality of oligonucleotides is 50 nm or less.

3. The method according to claim 1, wherein a difference between the Tm values of the plurality of oligonucleotides for each of the sequences of said regions to be hybridized containing the first genotype is 0 to 2° C.

4. The method according to claim 1, wherein a difference between the Tm values of the plurality of oligonucleotides for each of the sequences of said regions to be hybridized containing the first genotype is 0 to 1° C.

5. A method of detecting nucleotide polymorphisms, comprising, simultaneously or sequentially, performing the nucleotide polymorphism detection method according to claim 1 and a nucleotide polymorphism detection method using one or more fluorescent dye detection wavelengths other than the single wavelength used in the nucleotide polymorphism detection method according to claim 1.

6. A method of detecting nucleotide polymorphisms, comprising, simultaneously or sequentially, performing the nucleotide polymorphism detection method according to claim 1 and a nucleotide polymorphism detection method using two or more fluorescent dye detection wavelengths other than the single wavelength used in the nucleotide polymorphism detection method according to claim 1.

7. The method according to claim 1, wherein the first genotype-containing sequence is a wild type sequence and the second genotype-containing sequence is a sequence having a substitution mutation, an insertion mutation, and/or a deletion mutation of one or more nucleotides in the wild type sequence.

8. The method according to claim 1, wherein the oligonucleotides are nucleotide polymorphism detection probes in which the oligonucleotides emit fluorescence when not hybridized to a target sequence, and fluorescence intensity decreases or increases when the oligonucleotides are hybridized to the target sequence.

9. The method according to claim 8, wherein the oligonucleotides are nucleotide polymorphism detection probes in which the fluorescence intensity decreases when the oligonucleotides are hybridized to the target sequence.

10. A kit for simultaneously detecting a plurality of nucleotide polymorphisms at a single wavelength, the kit comprising nucleotide polymorphism detection probes comprising a plurality of oligonucleotides labeled with a fluorescent dye, each of which hybridizes to a region containing each of the plurality of nucleotide polymorphisms, wherein
a difference between detection wavelengths of the fluorescent dyes labeling the plurality of oligonucleotides is 200 nm or less,
a difference between Tm values of the plurality of oligonucleotides for each of the sequences of said regions to be hybridized containing a first genotype of the nucleotide polymorphisms is 4° C. or less; and
Tm value for the sequence of the region to be hybridized containing the first genotype is distant from Tm value for the sequence of said region to be hybridized containing a second genotype by 3° C. or more.

11. A method for predicting a medicinal efficacy and/or a physical predisposition in an individual, comprising measuring the presence or absence of a nucleotide polymorphism(s) associated with the medicinal efficacy and/or the physical predisposition, by detecting the plurality of nucleotide polymorphisms by the method according to claim 1.

12. A nucleotide polymorphism detection apparatus comprising:
a reaction section containing a plurality of oligonucleotides labeled with a fluorescent dye, each of which hybridizes to a region containing each of the plurality of nucleotide polymorphisms;
a liquid sending section feeding a sample and/or a reaction solution to the reaction section;
a light source section emitting light for exciting fluorescence in the reaction section;
a control section controlling temperature of the reaction section; and
a detection section detecting the fluorescence, wherein
a difference between detection wavelengths of the fluorescent dyes labeling the plurality of oligonucleotides is 200 nm or less, a difference between Tm values of the plurality of oligonucleotides for each of the sequences of said regions to be hybridized containing a first genotype of the nucleotide polymorphisms is 4° C. or less; and
Tm value for the sequence of the region to be hybridized containing the first genotype is distant from Tm value for the sequence of said region to be hybridized containing a second genotype by 3° C. or more.

13. A nucleotide polymorphism determination system comprising:
a reaction system containing a plurality of oligonucleotides labeled with a fluorescent dye, each of which hybridizes to a region containing each of the plurality of nucleotide polymorphisms;
a liquid sending system feeding a sample and/or a reaction solution to the reaction system;
a light source system emitting light for exciting fluorescence in the reaction system;
a control section controlling temperature of the reaction system;
a detection system detecting the fluorescence; and
a determination system determining the nucleotide polymorphism based on a detection result, wherein
a difference between detection wavelengths of the fluorescent dyes labeling the plurality of oligonucleotides is 200 nm or less,
a difference between Tm values of the plurality of oligonucleotides for each of the sequences of said regions to be hybridized containing a first genotype of the nucleotide polymorphisms is 4° C. or less; and
Tm value for the sequence of the region to be hybridized containing the first genotype is distant from Tm value for the sequence of said region to be hybridized containing a second genotype by 3° C. or more.


SEQUENCE LISTING (46 sequences)

SEQ ID NO: 1 - DNA, 50 bp, Artificial Sequence
  EGFR-e20-ins-WT-F
gaagcctacgtgatggccagcgtggacaacccccacgtgtgccgcctgct

SEQ ID NO: 2 - DNA, 59 bp, Artificial Sequence
  EGFR-e20-ins9-F
gaagcctacgtgatggccagcgtggccagcgtggacaacccccacgtgtgccgcctgct

SEQ ID NO: 3 - DNA, 53 bp, Artificial Sequence
  EGFR-e20-insCAC-F
gaagcctacgtgatggccagcgtggacaacccccaccacgtgtgccgcctgct

SEQ ID NO: 4 - DNA, 56 bp, Artificial Sequence
  EGFR-e20-insTGCGTG-F
gaagcctacgtgatggccagcgtgtgcgtggacaacccccacgtgtgccgcctgct

SEQ ID NO: 5 - DNA, 56 bp, Artificial Sequence
  EGFR-e20-insAACCCC-F
gaagcctacgtgatggccagcgtggacaaccccaacccccacgtgtgccgcctgct

SEQ ID NO: 6 - DNA, 56 bp, Artificial Sequence
  EGFR-e20-insCCCCAC-F
gaagcctacgtgatggccagcgtggacaacccccacccccacgtgtgccgcctgct

SEQ ID NO: 7 - DNA, 59 bp, Artificial Sequence
  EGFR-e20-insAACCCCCAC-F
gaagcctacgtgatggccagcgtggacaacccccacaacccccacgtgtgccgcctgct

SEQ ID NO: 8 - DNA, 56 bp, Artificial Sequence
  EGFR-e20-insCACGTG-F
gaagcctacgtgatggccagcgtggacaacccccacgtgcacgtgtgccgcctgct

SEQ ID NO: 9 - DNA, 17 bp, Artificial Sequence
  3PB-EGFR-insWT-R5
tgtccacgctggccatc

SEQ ID NO: 10 - DNA, 19 bp, Artificial Sequence
  3PB-EGFR-insWT-F4
ggacaacccccacgtgtgc

SEQ ID NO: 11 - DNA, 20 bp, Artificial Sequence
  3FL-EGFR-ins7-F1
acaacccccacaacccccac

SEQ ID NO: 12 - DNA, 50 bp, Artificial Sequence
  EGFR-e20-ins-WT-R1
agcaggcggcacacgtgggggttgtccacgctggccatcacgtaggcttc

SEQ ID NO: 13 - DNA, 59 bp, Artificial Sequence
  EGFR-e20-ins9-R2
agcaggcggcacacgtgggggttgtccacgctggccacgctggccatcacgtaggcttc

SEQ ID NO: 14 - DNA, 53 bp, Artificial Sequence
  EGFR-e20-insCAC-R3
agcaggcggcacacgtggtgggggttgtccacgctggccatcacgtaggcttc

SEQ ID NO: 15 - DNA, 56 bp, Artificial Sequence
  EGFR-e20-insTGCGTG-R5
agcaggcggcacacgtgggggttgtccacgcacacgctggccatcacgtaggcttc

SEQ ID NO: 16 - DNA, 56 bp, Artificial Sequence
  EGFR-e20-insAACCCC-R6
agcaggcggcacacgtgggggttggggttgtccacgctggccatcacgtaggcttc

SEQ ID NO: 17 - DNA, 56 bp, Artificial Sequence
  EGFR-e20-insCCCCAC-R7
agcaggcggcacacgtgggggtgggggttgtccacgctggccatcacgtaggcttc

SEQ ID NO: 18 - DNA, 59 bp, Artificial Sequence
  EGFR-e20-insAACCCCCAC-R8
agcaggcggcacacgtgggggttgtgggggttgtccacgctggccatcacgtaggcttc

SEQ ID NO: 19 - DNA, 56 bp, Artificial Sequence
  EGFR-e20-insCACGTG-R9
agcaggcggcacacgtgcacgtgggggttgtccacgctggccatcacgtaggcttc

SEQ ID NO: 20 - DNA, 17 bp, Artificial Sequence
  3PB-858-G-PM
ttggcccgcccaaaatc

SEQ ID NO: 21 - DNA, 21 bp, Artificial Sequence
  3PB-3A4-G-PM
taaatcgccgctctcctgccc

SEQ ID NO: 22 - DNA, 50 bp, Artificial Sequence
  858-mm
caagatcacagattttgggctggccaaactgctgggtgcggaagagaaag

SEQ ID NO: 23 - DNA, 50 bp, Artificial Sequence
  858-PM
caagatcacagattttgggcgggccaaactgctgggtgcggaagagaaag

SEQ ID NO: 24 - DNA, 40 bp, Artificial Sequence
  3A4-mm
agccatagagacaagggcaagagagaggcgatttaataga

SEQ ID NO: 25 - DNA, 40 bp, Artificial Sequence
  3A4-PM
agccatagagacaagggcaggagagaggcgatttaataga

SEQ ID NO: 26 - DNA, 17 bp, Artificial Sequence
  3T-719-G-PM
gcaccggagcccagcac

SEQ ID NO: 27 - DNA, 17 bp, Artificial Sequence
  3T-858-G-PM
ttggcccgcccaaaatc

SEQ ID NO: 28 - DNA, 22 bp, Artificial Sequence
  3T-790-T-PM
tgagctgcatgatgaggtgcac

SEQ ID NO: 29 - DNA, 50 bp, Artificial Sequence
  719-G
gaattcaaaaagatcaaagtgctgggctccggtgcgttcggcacggtgta

SEQ ID NO: 30 - DNA, 50 bp, Artificial Sequence
  719-C
gaattcaaaaagatcaaagtgctggcctccggtgcgttcggcacggtgta

SEQ ID NO: 31 - DNA, 50 bp, Artificial Sequence; identical to SEQ ID NO: 23
  858-G

SEQ ID NO: 32 - DNA, 50 bp, Artificial Sequence; identical to SEQ ID NO: 22
  858-T

SEQ ID NO: 33 - DNA, 50 bp, Artificial Sequence
  790-T
cctcacctccaccgtgcagctcatcatgcagctcatgcccttcggctgcc

SEQ ID NO: 34 - DNA, 50 bp, Artificial Sequence
  790-C
cctcacctccaccgtgcagctcatcacgcagctcatgcccttcggctgcc

SEQ ID NO: 35 - DNA, 16 bp, Artificial Sequence
  5PB-V12M-A-PM
ccttgtgacattggga

SEQ ID NO: 36 - DNA, 19 bp, Artificial Sequence
  3PB-UGT-T-PM
gagacagagcattttacac

SEQ ID NO: 37 - DNA, 24 bp, Artificial Sequence
  5FL-Q126X-T-PM
cccacttatacttacttataccac

SEQ ID NO: 38 - DNA, 16 bp, Artificial Sequence
  3FL-NAT-C-PM
tgccgtcagtggtcac

SEQ ID NO: 39 - DNA, 50 bp, Artificial Sequence
  V12M-PM
cagtaatgtcgaagtttttatcccaatgtcacaaggaaacaccaatggct

SEQ ID NO: 40 - DNA, 50 bp, Artificial Sequence
  V12M-mm
cagtaatgtcgaagtttttatcccagtgtcacaaggaaacaccaatggct

SEQ ID NO: 41 - DNA, 40 bp, Artificial Sequence
  UGT-PM
ttcaaggtgtaaaatgctctgtctctgatgtacaacgagg

SEQ ID NO: 42 - DNA, 40 bp, Artificial Sequence
  UGT-mm
ttcaaggtgtaaaatgctccgtctctgatgtacaacgagg

SEQ ID NO: 43 - DNA, 50 bp, Artificial Sequence
  Q126X-PM
caaatgtaattcaggttacgtggtataagtaagtattagtgggtttgcat

SEQ ID NO: 44 - DNA, 50 bp, Artificial Sequence
  Q126X-mm
caaatgtaattcaggttacgtggtacaagtaagtattagtgggtttgcat

SEQ ID NO: 45 - DNA, 40 bp, Artificial Sequence
  NAT-PM
ccttctcctgcaggtgaccactgacggcaggaattacatt

SEQ ID NO: 46 - DNA, 40 bp, Artificial Sequence
  NAT-mm
ccttctcctgcaggtgaccattgacggcaggaattacatt